(19) United States
(12) Patent Application Publication
(10) Pub. No.: US 2017/0064279 A1
(43) Pub. Date: Mar. 2, 2017

(54) MULTI-VIEW 3D VIDEO METHOD AND SYSTEM

(71) Applicants: National Taiwan University, Taipei (TW); Himax Technologies Limited, Tainan City (TW)

(72) Inventors: Shao-Yi Chien, Taipei (TW); Yung-Lin Huang, Taipei (TW); Yi-Nung Liu, Tainan City (TW)

(21) Appl. No.: 14/842,764

(22) Filed: Sep. 1, 2015

(51) Int. Cl. H04N 13/00; G06T 19/20; G06T 7/00; G06T 17/00

(52) U.S. Cl. CPC H04N 13/0018; H04N 13/0037; H04N 13/0022; H04N 13/0029; G06T 17/00; G06T 19/20; G06T 7/0065; H04N 2013/0077; H04N 2013/0081; G06T 2200/04; G06T 2207/10024; G06T 2207/10028

(57) ABSTRACT

A multi-view 3D video method and system are disclosed. 3D points of an initial 3D model are projected back into back-projected points in image space. The back-projected points are compared with pixel points in next frames from multiple viewpoints. The pixel points in the next frames are updated according to comparing result between the back-projected points and the pixel points. Depth of the back-projected point is point-wise compared with depth of the corresponding pixel point. A farther point of the back-projected point and the corresponding pixel point, which are not similar in depth, are preserved, and the preserved farther point is used to update the pixel point in the next frame.

### BACKGROUND OF THE INVENTION

1. Field of the Invention

The present invention generally relates to multi-view 3D video, and more particularly to 3D background modeling in multi-view RGB-D video.

2. Description of Related Art

Nowadays, 3D video has reached a high level of maturity in both capture and display devices such as camera, cinemas, TV, mobile phones, etc. 3D video can be regarded as advanced functionalities that expand the capabilities of a 2D video, providing people with a 3D depth impression of the observed scene. In addition, to give people more immersive viewing experience, multiple cameras have been used to capture multi-view 3D video. These 3D techniques benefit many computer vision researches. Take augmented reality (AR) for example, some researchers utilize 3D camera to enhance the performance of AR applications. More specifically, it reconstructs the 3D model in video instead of estimating the camera poses only.

One way to produce 3D video is to extract 3D information from 2D video using 2D-3D conversion. However, the retrieved 3D information might be unreal due to the misestimated depth. Recently, stereo camera and camera array are more widely used to capture stereoscopic video. With these advanced devices, multiple viewpoints of one scene can be captured at the same time, preserving more 3D information than before. That is, the depth maps of each viewpoint can be estimated more robustly.

To achieve high performance in various applications, many video codec standards such as H.264/MPEG-4 AVC and High Efficiency Video Coding (HEVC) are developed. The 3D video technology is also included in the multi-view video coding (MVC). To encode efficiently the 3D information for free-viewpoint TV (FTV) application, the 3D information is recorded as a depth map along with each video frame. This introduces multi-view video plus depth, so-called multi-view 3D video or multi-view RGB-D video.

3D scene reconstruction methods aim to capture the shape and appearance of real scene, and it has been a popular topic in computer vision, computer graphics and robotics. In general, most researches assume static 3D scene because the dynamic 3D object reconstruction remains a challenging issue.

### SUMMARY OF THE INVENTION

In view of the foregoing, it is an object of the embodiment of the present invention to provide multi-view 3D video method and system. A 3D model is first reconstructed, and the following frames will be updated into it using updating strategy. Accordingly, the dynamic objects can be excluded and a compact 3D background model remained.

According to one embodiment, an initial 3D model is provided. 3D points of the initial 3D model are projected back into back-projected points in image space. The back-projected points are compared with pixel points in next frames from multiple viewpoints. The pixel points in the next frames are updated according to comparing result between the back-projected points and the pixel points. In the step for comparing the back-projected points with the pixel points, depth of the back-projected point is point-wise compared with depth of the corresponding pixel point; and a farther point of the back-projected point and the corresponding pixel point, which are not similar in depth, are preserved, and the preserved farther point is used to update the pixel point in the next frame.

### BRIEF DESCRIPTION OF THE DRAWINGS

FIG. 1A shows a flow diagram illustrated of a multi-view 3D video method according to one embodiment of the present invention;

FIG. 1B shows a block diagram illustrating a multi-view 3D video system according to the embodiment of the present invention;

FIG. 2 shows an example of FIG. 1A/1B;

FIG. 3 schematically shows a camera array used to capture the multi-view RGB-D video of FIG. 1A/1B; and

FIG. 4 shows a detailed flow diagram of step 15 of FIG. 1A.

### DETAILED DESCRIPTION OF THE INVENTION

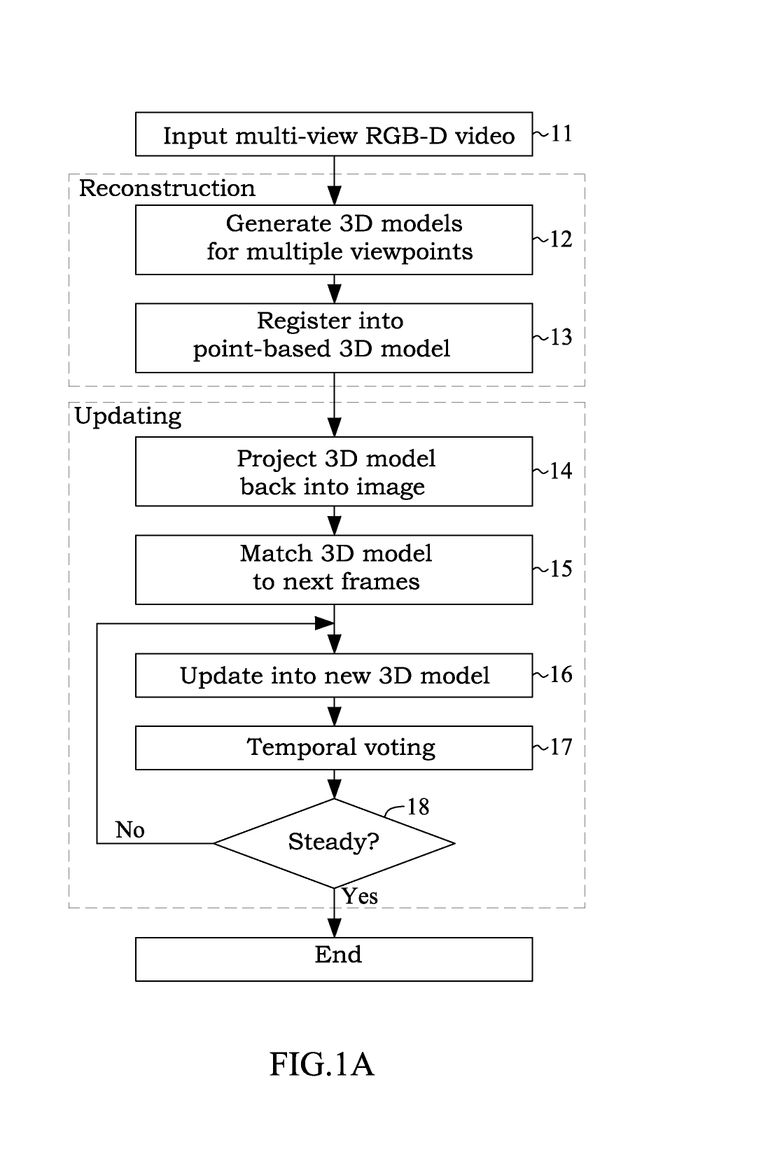

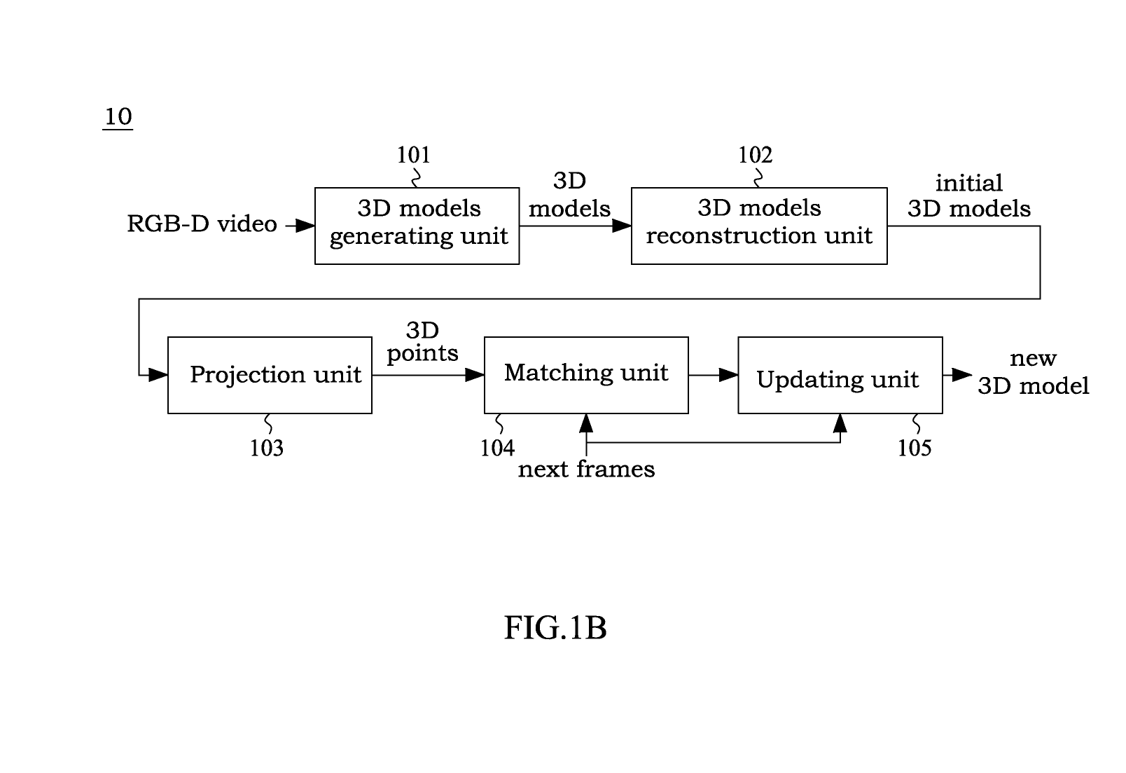

FIG. 1A shows a flow diagram illustrated of a multi-view 3D video method according to one embodiment of the present invention. The method shown in FIG. 1A may be operated by a processor such as a digital image processor. FIG. 1B shows a block diagram illustrating a multi-view 3D video system 10 according to the embodiment of the present invention. The blocks of the multi-view 3D video system 10 may be implemented by circuits that construct a processor such as a digital image processor. For better understanding the embodiment, FIG. 2 shows an example of FIG. 1A/1B.

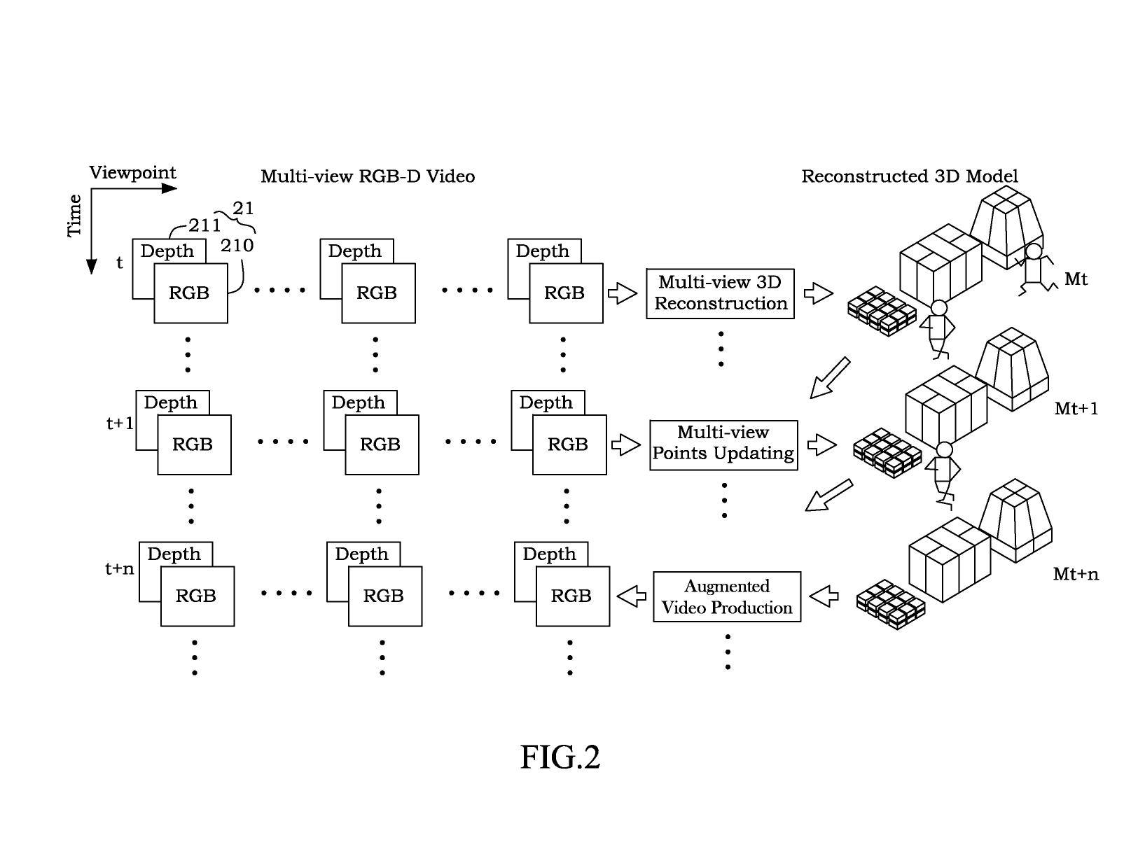

In step 11, multi-view RGB-Depth (or RGB-D) video is inputted. As exemplified in FIG. 2, at each time (e.g., time t), the multi-view RGB-D video includes a plurality of frames 21 from multiple viewpoints, respectively. Each frame 21 includes a color image 210 and a corresponding depth map 211. FIG. 3 schematically shows a camera array including plural cameras 31, which correspond to multiple viewpoints, respectively. The camera array can be used in the embodiment to capture the multi-view RGB-D video. The captured color images 210 and corresponding depth maps 211 are then sent to and processed by a digital image processor 32.

Next, in step 12, 3D models are generated for multiple viewpoints, respectively, by using first frames 21 (at time t) of multiple viewpoints. Step 12 of the embodiment may be performed by a 3D models generating unit 101. Subsequently, in step 13, the generated 3D models are registered into a generic 3D model by a 3D model reconstruction unit 102, thereby reconstructing a point-based (initial) 3D model (e.g., Mt). Notice that the 3D reconstruction is only performed on the first frames. As the frames 21 from multiple viewpoints in the same time stamp can be treated as a static scene, conventional 3D reconstruction techniques for static scene may be adopted to carry out step 12 and step 13 of the embodiment.

Specifically, the relationship between camera image plane and world coordinate can be formulated as a camera intrinsic matrix K. Given a 2D pixel p=(x, y)^{T}εR², and its corresponding 3D point PεR³ can be determined uniquely as P=D(p)K⁻¹(p^{T},1)^{T} with the aid of depth map D.

For depth map in 3D video, the real depth may, for example, be nonlinearly quantized into 256 levels to be stored as an image. The real depth Z of a depth value D(p) can be restored as

$$Z = 1 / [ \frac{D ( p )}{255} \cdot ( \frac{1}{{z}_{min}} - \frac{1}{{z}_{max}} ) + \frac{1}{{z}_{max}} ] .$$

In addition, the color information of each point can be directly derived from the corresponding color images.

The relationship among the data captured from different viewpoints can be formulated as a 6 degrees of freedom (6-DoF) rigid transformation. The transformation can be derived from the camera extrinsic matrices, which describe the 6-DoF rigid transformation, including the rotation R and the translation t. On the other hand, if the extrinsic matrices are unknown, the registration techniques can be employed to derive the appropriate transformation.

A two-stage registration framework is often used in previous works: a global estimation method, followed by a local refinement. Details may be referred to “RGB-D mapping: Using Kinect-style depth cameras for dense 3D modeling of indoor environments,” entitled to P. Henry et al., April 2012, Int. J. Rob. Res., 31(5):647-663, and “Point-based model construction for free-viewpoint TV,” entitled to K.-C. Wei et al., September 2013, IEEE International Conference on Consumer Electronics—Berlin (ICCE—Berlin), pages 220-221, the disclosures of which are incorporated herein by reference. Moreover, a further global optimization is required to handle the loop closure problem when reconstructing a large-scale scene. Nevertheless, for registration between different viewpoints in 3D video, a global estimation method can achieve acceptable results without further refinement. Even if the registration is not perfect without local refinement, our following multi-view points updating can tolerate it. In addition, there is no loop closure problem among multiple viewpoints.

In our system, SIFT feature points instead of all points in the 3D model are used to reduce the search space effectively. Details about SIFT feature points may be referred to “Distinctive image features from scale-invariant keypoints,” entitled to D. G. Lowe, November 2004, Int. J. Comput. Vision, 60(2):91-110, the disclosure of which is incorporated herein by reference. Also, to reduce the effect from incorrect correspondence caused by improper feature matching, random sample consensus (RANSAC) is employed. The 3D transformation [R|t] is then computed to least-square minimize between these feature pairs.

Subsequently, in step 14, 3D point of the initial 3D model reconstructed in step 13 is projected back into image by a projection unit 103, thereby resulting in back-projected points. Accordingly, a 3D model may be compared with an image pixel later in order to perform matching to next frames 21 (e.g., at time t+1) of plural viewpoints, in step 15, in image space instead of 3D space because the depth of 3D video is estimated by stereo matching which operates in image space. Step 15 of the embodiment may be performed by a matching unit 104. Finally, in step 16, those pixels without points projected are new and then updated into new 3D model (e.g., Mt+1) by an updating unit 105. Accordingly, pixels in following frames are updated into the 3D model.

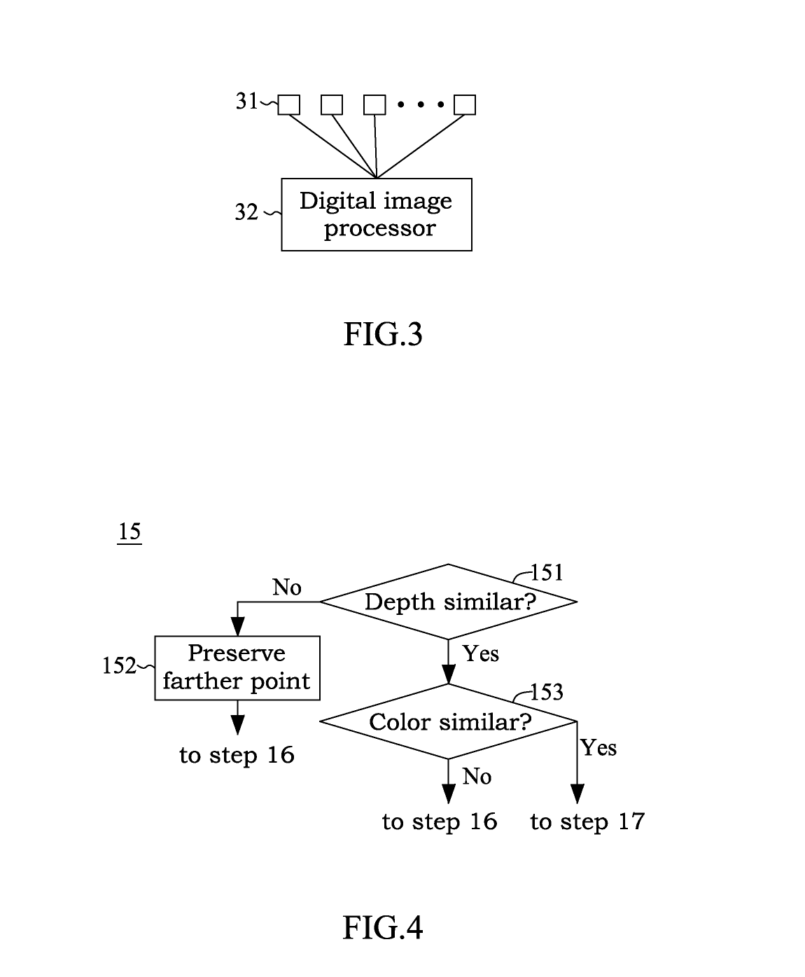

FIG. 4 shows a detailed flow diagram of step 15 of FIG. 1A. In step 151, depth of the back-projected point is compared point-wise with depth of corresponding point in the next frame for each viewpoint. If they are not similar in depth, that is, difference between them is greater than a threshold value, a farther (or background) point of them is preserved (step 152), and is used in the succeeding updating step 16. However, if the back-projected point and the corresponding point are similar in depth, color of them is compared point-wise in step 153. If they are not similar in color, that is, difference between them is greater than a threshold value, color of the corresponding point in the next frame is used in the succeeding updating step 16.

While performing updating, nevertheless, most pixels have corresponding projected points. In other words, these pixels are likely to be similar or in conflict with the existing 3D points. To identify how these image pixels should be updated, a background modeling cost function F(p, p_{i,t+1}) between each projected point p and its corresponding image pixel p_{i,t+1} is evaluated. The function can be expressed as

F(p,p_{i,t+1})=αGeo(p,p_{i,t+1})+(1−α)App(p,p_{i,t+1})

where Geo(•,•) measures geometry constraint, App(•,•) measures appearance constraint and α is an adaptive weighting.

Specifically, Geo(p, p_{i,t+1})=D(p)−D(p_{i,t+1}), which performs z-test using the depth values. In 3D video, the largest depth value 255 represents the closest distance. Hence, positive Geo(•,•) indicates that the 3D point is likely to originate from dynamic object because its projected point goes closer than its corresponding pixel. This usually happens when the object is reconstructed in 3D model at first but moves away later. Besides, the appearance constraint is measured using L2 distance in CIELAB space between the projected point and pixel as App(p, p_{i,t+1})=∥Lab(p)−Lab(p_{i,t+1})∥.

To preserve the static points more, the adaptive weighting α is determined by Geo(•,•) In our system, α=0 when Geo(•, •) is close to zero, otherwise α=1. That is, the appearance constraint is measured only when the geometry constraint gives an ambiguous result.

Now given a 3D point, the background modeling cost function with respect to each viewpoint can be calculated. The lower the cost is, the more possible the point belongs to static background. Therefore, for each viewpoint, it can distinguish the 3D point from static background by simply thresholding the cost.

In one embodiment, a temporal multi-view voting step 17 may be further performed to increase the robustness. Specifically, the 3D point will be updated only when it is regarded as a dynamic point in all viewpoints during a period of time. The 3D point will be removed and its corresponding pixels in each view will be updated into the new 3D model (e.g., Mt+1). It is noted that the corresponding pixels with low background modeling cost will not be updated to keep the 3D model compact.

Step 14 through step 17 are performed many times until the 3D model is steady (step 18). To steady the 3D model, only static background pixels are updated and dynamic object points are excluded. In the embodiment, the frames 21 used for generating 3D model are highly correlated. Therefore, the color and illumination of points variant are smaller, introducing point-to-pixel matching possible. On the other hand, 3D model points are hardly matched to image pixels in conventional methods because, for example, the model is generated from large image collection using structure from motion (SfM).

According to the embodiment discussed above, the 3D model is updated using the following multi-view video frames 21. After certain frames, the 3D model will be steadied with only static background remained. The reconstructed 3D (background) model according to the embodiment may then be applied to computer vision such as augmented video production and motion object segmentation. For example, augmented reality (AR) combines real-world environment and computer-generated model. Given a video, AR aims to recover the camera poses of the video. With the estimated camera poses, the virtual objects can be registered to the video as if they are captured in the real world. The video augmented with virtual objects can be called as augmented video.

According to the embodiment discussed above, a 3D reconstruction system for multi-view 3D video is proposed. The point-based 3D model is first reconstructed, and then updated into a static background model. The 3D reconstruction method is adapted to perform only a global estimation. Our proposed multi-view points updating evaluate if the 3D model required to be updated using the following frames. Finally, the compact 3D background model is there and can further help produce augmented video.

Although specific embodiments have been illustrated and described, it will be appreciated by those skilled in the art that various modifications may be made without departing from the scope of the present invention, which is intended to be limited solely by the appended claims.

What is claimed is:

1. A multi-view 3D video method, comprising:
providing an initial 3D model;
projecting back 3D points of the initial 3D model into back-projected points in image space;
comparing the back-projected points with pixel points in next frames from multiple viewpoints; and
updating the pixel points in the next frames according to comparing result between the back-projected points and the pixel points;
wherein the step for comparing the back-projected points with the pixel points comprises:
comparing depth of the back-projected point point-wise with depth of the corresponding pixel point; and
preserving a farther point of the back-projected point and the corresponding pixel point, which are not similar in depth, the preserved farther point being used to update the pixel point in the next frame.

2. The method of claim 1, wherein the step for comparing the back-projected points with the pixel points further comprises:
if the back-projected point and the corresponding pixel point are similar in depth, utilizing color of the corresponding pixel point to update the pixel point in the next frame, wherein the back-projected point and the corresponding pixel point are not similar in color.

3. The method of claim 1, further comprising:
performing a temporal multi-view voting step such that the pixel points in the next frames are updated only when the pixel points are regarded as dynamic points in all viewpoints during a period of time.

4. The method of claim 1, wherein the first frames construct multi-view RGB-Depth video.

5. The method of claim 1, wherein the initial 3D model is reconstructed according to first frames from multiple viewpoints respectively, each of the first frames including a color image and a corresponding depth map.

6. The method of claim 5, wherein the initial 3D model is reconstructed by the following steps:
generating a plurality of 3D models for multiple viewpoints, respectively, by using the first frames; and
registering the generated 3D models into the initial 3D model.

7. A multi-view 3D video system, comprising:
a camera array including a plurality of cameras corresponding to multiple viewpoints, respectively, used to capture first frames from multiple viewpoints respectively;
a projection unit that projects back 3D points of an initial 3D model into back-projected points in image space;
a matching unit that compares the back-projected points with pixel points in next frames from multiple viewpoints; and
an updating unit that updates the pixel points in the next frames according to comparing result between the back-projected points and the pixel points;
wherein the matching unit performs the following steps:
comparing depth of the back-projected point point-wise with depth of the corresponding pixel point; and
preserving a farther point of the back-projected point and the corresponding pixel point, which are not similar in depth, the preserved farther point being used to update the pixel point in the next frame.

8. The system of claim 7, wherein the matching unit further performs the following step:
if the back-projected point and the corresponding pixel point are similar in depth, utilizing color of the corresponding pixel point to update the pixel point in the next frame, wherein the back-projected point and the corresponding pixel point are not similar in color.

9. The system of claim 7, wherein the updating unit further performs a temporal multi-view voting step such that the pixel points in the next frames are updated only when the pixel points are regarded as dynamic points in all viewpoints during a period of time.

10. The system of claim 7, wherein the first frames construct multi-view RGB-Depth video.

11. The system of claim 7, wherein the initial 3D model is reconstructed according to the first frames from multiple viewpoints respectively, each of the first frames including a color image and a corresponding depth map.

12. The system of claim 11, further comprising:
a 3D models generating unit that generates a plurality of 3D models for multiple viewpoints, respectively, by using the first frames; and
a 3D model reconstruction unit that registers the generated 3D models into the initial 3D model.
